(19) United States
(12) Patent Application Publication
(10) Pub. No.: US 2014/0173216 A1
(43) Pub. Date: Jun. 19, 2014

(54) Invalidation of Dead Transient Data in Caches

(71) Applicant: ADVANCED MICRO DEVICES, INC., Sunnyvale, CA (US)

(72) Inventors: Nuwan S. JAYASENA, Sunnyvale, CA (US); Mark D. HILL, Madison, WI (US)

(73) Assignee: Advanced Micro Devices, Inc., Sunnyvale, CA (US)

(21) Appl. No.: 13/718,398

(22) Filed: Dec. 18, 2012

(51) Int. Cl. G06F 12/08

(52) U.S. Cl. CPC G06F 12/0802
USPC 711/135

(57) ABSTRACT

Embodiments include methods, systems, and articles of manufacture directed to identifying transient data upon storing the transient data in a cache memory, and invalidating the identified transient data in the cache memory.

### BACKGROUND

1. Field

The present disclosure is generally directed to improving the performance and energy efficiency of caches.

2. Background Art

Many applications have large amounts of transient data that are generated and consumed within a short or limited time span and are never referenced again. Transient data includes temporary values generated or accessed during computations and intermediate results of computations. Transient data is considered to be “dead” (“expired”) beyond the useful lifetime of that data after which it is never referenced. Transient data may expire after the execution has completed of the particular process, (also herein referred to interchangeably as thread or kernel) that created that transient data, or even during the execution of that process. Dead transient data may reside in caches for long durations, well beyond the respective lifetimes of that data. Having dead transient data occupy cache space for long durations can result in inefficiencies in performance and energy. Such dead transient data occupies cache space that could be allocated to more useful live data and also incurs the performance and energy cost of writing such dead data out to external memory when dirty (e.g. dirty bit turned on) cache lines are evicted from caches.

Studies have shown that for some media processing and scientific computing applications, a high percentage of all external memory (e.g. dynamic random access memory) traffic consists of writing out transient data that is no longer live (e.g. dead data). This is often the case even with extremely careful cache management at the application level.

Conventional systems provide for invalidating a cache line on the last read of the data in question, provide instructions for invalidating or flushing entire caches, provide for the invalidation or flushing of a range of addresses, and provide for predicting the last use of a data item in a cache so that the line can be proactively evicted from the cache. Yet other conventional systems introduce an epoch-based technique that invalidates dead data to improve the performance of hardware managed caches in the specialized context of stream programming models. However, each of the conventional approaches noted above are inadequate to provide for efficiently removing transient data from caches so that more cache space is available for live data, and so that dead transient data is not unnecessarily written back to main memory in general-purpose programming models and computing systems.

### SUMMARY OF EMBODIMENTS

Embodiments provide for reducing the inefficiency due to transient data management in caches by distinguishing transient data in caches and proactively invalidating them when no longer needed.

Embodiments include methods, systems, and articles of manufacture directed to identifying transient data upon storing the transient data in a cache memory, and invalidating the identified transient data in the cache memory.

Further features, advantages and embodiments, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the disclosed embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a system for distinguishing transient data in caches and proactively invalidating them when no longer needed, in accordance with some embodiments.

FIG. 2A is a block diagram illustrating a cache line configuration, in accordance with some embodiments.

FIG. 2B is a block diagram illustrating a cache line configuration that supports a plurality of separate transient data areas, in accordance with some embodiments.

FIG. 3 is a flowchart illustrating an exemplary compiling of a process, according to some embodiments.

FIG. 4 is a flowchart of a method for maintaining a cache, according to some embodiments.

FIG. 5 is a flowchart of a method for inserting a cache entry, according to some embodiments.

The features and advantages of the disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “embodiments” does not require that all embodiments include the discussed feature, advantage or mode of operation. Alternate embodiments may be devised without departing from the scope of the disclosure, and well-known elements may not be described in detail or may be omitted so as not to obscure the relevant details. In addition, the terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Conventional cache management policies, including hardware cache management policies, do not differentiate between transient and long-lived data. Therefore, transient data can live on in caches well beyond their useful lifetime resulting in inefficiencies such as occupying cache space that could be allocated to more useful live data. Transient data can also cause substantial performance and energy costs due to the writing of dead (expired) data out to external memory when dirty transient cache lines are finally evicted from on-chip caches.

Conventional techniques provide for invalidating a cache line on the last read of the data in question, provide instructions for invalidating or flushing entire caches, provide for the invalidation or flushing of a range of addresses, and provide for predicting the last use of a data item in a cache so that the line can be proactively evicted from the cache. However, none of these conventional techniques can efficiently track and invalidate transient data.

For example, the conventional techniques to invalidate a single cache line at a time requires the application writer or software tools to identify what data to invalidate at a cache line granularity and incurs the performance overhead of invalidating each cache line individually using software. Invalidating a cache line on the last read of the data burdens the application writer or software tools with identifying the last read of all data words mapped to a cache line. The analysis necessary for identifying the last read of a data is difficult, and also is dependent on the cache line size of machines leading to possible incorrect executions on machines with cache line sizes that do not match.

The conventional technique providing for invalidating or flushing entire caches does not allow for selective elimination of only transient data, and thus leads to inefficiencies by eliminating useful data from the cache. The conventional technique providing for the invalidation or flushing of a range of addresses requires to be implemented as long-latency operations that serially walk through the cache and probes for each cache block within the specified address range and cannot be implemented as fast operations, thus limiting their usefulness. Additionally, the conventional technique of predicting the last use of a data item in a cache so that the line can be proactively evicted from the cache is a speculative technique that cannot reliably invalidate dirty lines, and therefore still require writing the contents of dirty lines out to external memory on evictions.

Data movement and external memory accesses are dominant consumers of energy and significant performance limiters. Proactively invalidating dead (e.g. expired) data as enabled by embodiments increases the effective available cache capacity and reduces unnecessary writes to external memory, thereby enabling significant energy savings and performance benefits.

The techniques described here can track transient data at a cache line granularity and bulk-invalidate them with minimal performance and energy overheads. This makes it practical to perform these invalidations even at a very fine granularity (e.g. invalidate local data at the end of a function call).

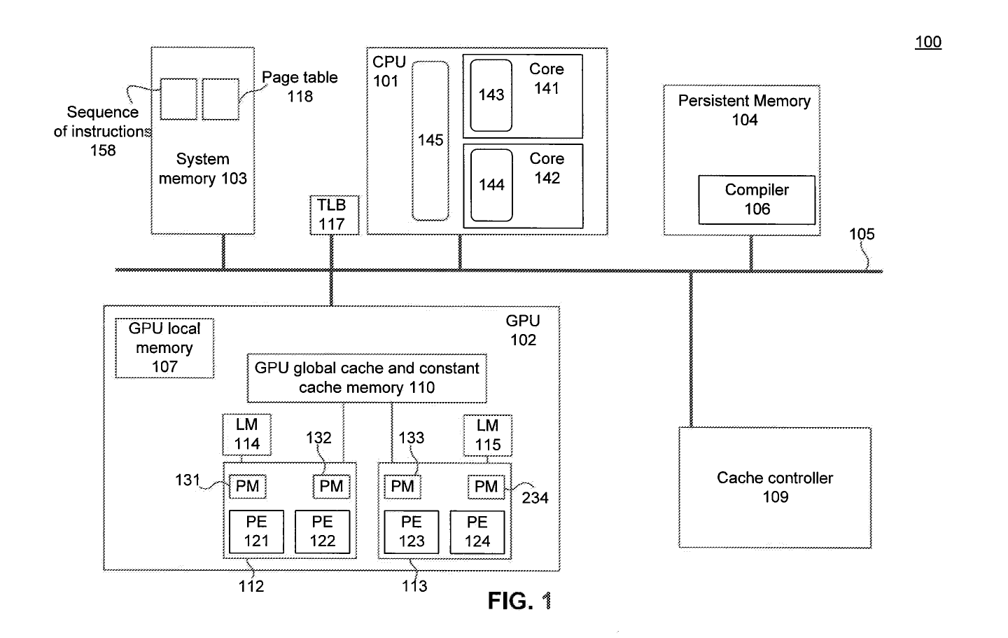

FIG. 1 is a block diagram illustration of a system 100 that can perform invalidation of transient data in caches, in accordance with some embodiments. In FIG. 1, an example heterogeneous computing system 100 can include one or more central processing units (CPUs), such as CPU 101, and one or more data-parallel processors, such as graphics processing unit (GPU) 102. Heterogeneous computing system 100 can also include system memory 103, a persistent memory 104, a system bus 105, a compiler 106, and a cache controller 109.

CPU 101 can include a commercially available control processor or a custom control processor. CPU 101, for example, executes the control logic that controls the operation of heterogeneous computing system 100. CPU 101 can include one or more cores, such as cores 141 and 142. CPU 101, in addition to any control circuitry, may include cache memories, such as CPU cache memories 143 and 144 associated respectively with cores 141 and 142, and CPU cache memory 145 associated with both cores 141 and 142. In some embodiments, cache memories 143, 144 and 145 may be structured as a hierarchical cache (e.g. 143 and 144 being level 1 caches and 145 being a level 2 cache). CPU cache memories can be used to store instructions, data and/or parameter values during the execution of an application on the CPU.

GPU 102 can be any data-parallel processor. GPU 102, for example, can execute specialized code for selected functions for graphics processing or computation. Selected graphics or computation functions that are better suited for data-parallel processing can be more efficiently run on GPU 102 than on CPU 101.

In this example, GPU 102 includes a GPU global cache memory 110 and a plurality of compute units 112 and 113. A GPU local memory 107 can be included in, or coupled to, GPU 102. Each compute unit 112 and 113 is associated with a GPU local memory 114 and 115, respectively. Each compute unit includes one or more GPU processing elements (PE). For example, compute unit 112 includes GPU processing elements 121 and 122, and compute unit 113 includes GPU PEs 123 and 124.

Each GPU processing element 121, 122, 123, and 124, is associated with at least one private memory (PM) 131, 132, 133, and 134, respectively. Each GPU PE can include one or more of a scalar and vector floating-point units. The GPU PEs can also include special purpose units, such as inverse-square root units and sine/cosine units. GPU global cache memory 110 can be coupled to a system memory, such as system memory 103, and/or graphics memory, such as GPU local memory 107.

According to an embodiment, in system 100, GPU 102 may be used as a specialized accelerator for selected functions. GPU 102 is substantially more efficient than CPU 101 for many graphics related functions, as well as for tasks such as, but not limited to, ray tracing, computational fluid dynamics and weather modeling that involve a high degree of parallel computations. GPUs used for non-graphics related functions are sometimes referred to as general purpose graphics processing units (GPGPU). Additionally, in some embodiments, CPU 101 and GPU 102 may be on a single die.

System memory 103 can include at least one non-persistent memory, such as dynamic random access memory (DRAM). System memory 103 can store processing logic instructions, constant values, and variable values during execution of portions of applications or other processing logic. The term “processing logic,” as used herein, refers to control flow instructions, instructions for performing computations, and instructions for associated access to resources.

System 100, in some embodiments, may also include a Translation Lookaside Buffer (TLB) 117. TLB 117 is a cache used to efficiently access page translations. For example, TLB 117 caches some virtual to physical address translations that are performed so that any subsequent accesses to the same pages can use the TLB 117 entries rather than performing the translation. The TLB is typically implemented as content-addressable memory (CAM) within a processor, such as CPU 101. A CAM search key is a virtual address and a search result is a physical address. If the requested address is present in the TLB, the CAM search yields a match and the retrieved physical address can be used to access memory. This is referred to as a TLB hit. If the requested address is not in the TLB (referred to as a TLB miss), and the translation may proceed by looking up the page table 118 in a process referred to as a page walk. The page table is in memory (such as system memory 103), and therefore page walk is an expensive process, as it involves reading the contents of multiple memory locations and using them to compute the physical address. After the physical address is determined by the page walk, the virtual address to physical address mapping is stored in the TLB.

Persistent memory 104 includes computer readable media, such as one or more storage devices capable of storing digital data, such as magnetic disk, optical disk, or flash memory. Persistent memory 104 can, for example, store at least parts of logic of compiler 106 and cache controller 109. At the startup of heterogeneous computing system 100, the operating system and other application software can be loaded in to system memory 103 from persistent storage 104.

System bus 105 can include a Peripheral Component Interconnect (PCI) bus, Industry Standard Architecture (ISA) bus, PCI Express (PCIe) or Accelerated Graphics Port (AGP) or such a device. System bus 105 can also include a network, such as a local area network (LAN), along with the functionality to couple components, including components of heterogeneous computing system 100.

Although shown in FIG. 1 as located outside of any processors, cache controller 109 may be implemented as a component of CPU 101 and/or GPU 102. For example, cache controller 109 may be a part of the logic of a cache management hardware and/or software for one or more of caches 143, 144, 145 and 110, where cache controller 109 is responsible for marking and updating the marking of cache lines to distinguish transient and long-lived data stored in cache lines.

A person of skill in the art will understand that cache controller 109 can be implemented using software, firmware, hardware, or any combination thereof. In one embodiment, some or all of the functionality of cache controller 109 is specified in a hardware description language, such as Verilog, RTL, netlists, etc. to enable ultimately configuring a manufacturing process through the generation of maskworks/photomasks to generate a hardware device embodying aspects described herein. Compiler 106 may be implemented in software. For example, compiler 106 can be a computer program written in programming languages such as, but not limited to, C, CUDA (“Compute Unified Device Architecture”) or OpenCL, that when compiled and executing resides in system memory 103. In source code form and/or compiled executable form, compiler 106 and/or cache controller 109 can be stored in persistent memory 104. Note that compiler 106 is shown in persistence 104 only as an example. A person of skill in the art would appreciate that, based on this disclosure, compiler 106 may include components in one or more of persistent memory 104, system memory 103, and hardware.

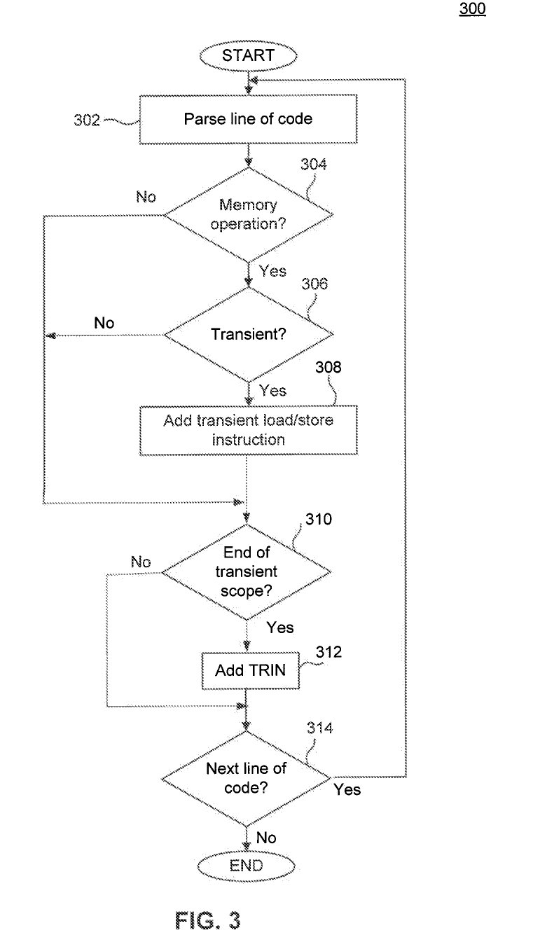

Compiler 106 includes logic to analyze the code (e.g. in source code form or in an intermediate binary code form) for processes and either automatically or with programmer assistance insert instructions, such as instructions to identify transient memory accesses and/or instructions to invalidate transient memory operations, in the sequence of instructions (e.g. instructions of a process) to be executed on a processor, such as sequence of instructions 158. The inserted instructions can selectively invalidate dead transient data in caches. Instructions may also be inserted to identify particular memory accesses as including transient data. Processing in compiler 106 is described below in relation to FIG. 3.

Cache controller 109 includes logic to identify transient data and mark such data as transient in hardware in a cache. Cache controller 109 also includes logic to maintain the live or dead status of transient data and also to efficiently invalidate dead transient data in response to system conditions and/or particular instructions. Note that cache controller 109 is shown in directly coupled to system bus 105 only as an example. A person of skill in the art would appreciate that, based on this disclosure, cache controller 109 may include components in one or more of persistent memory 104, system memory 103, and hardware.

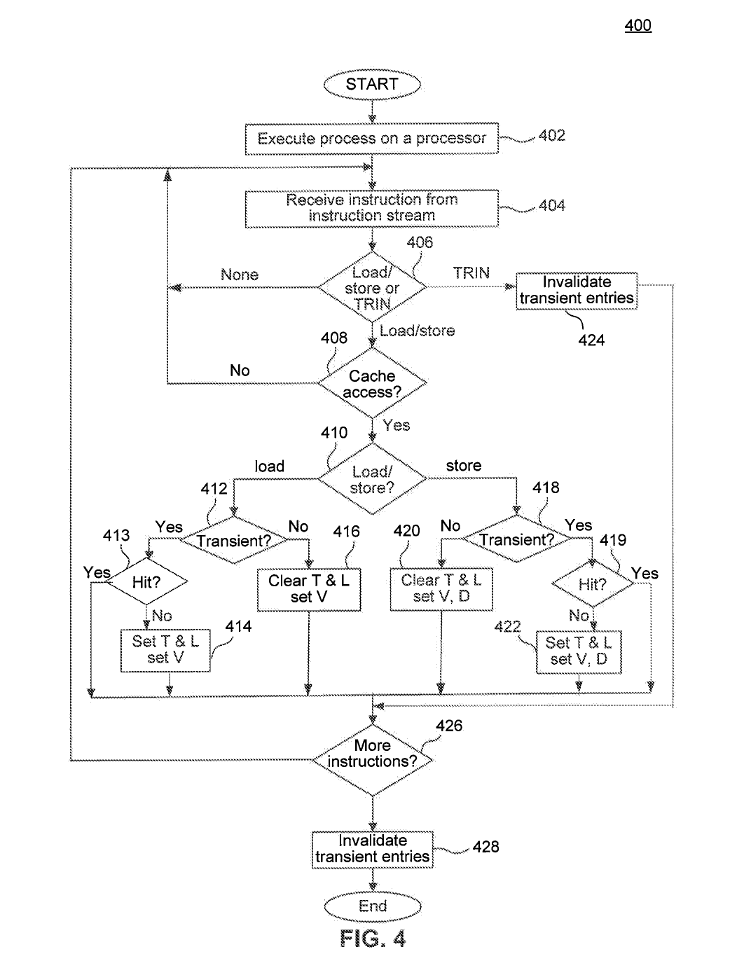

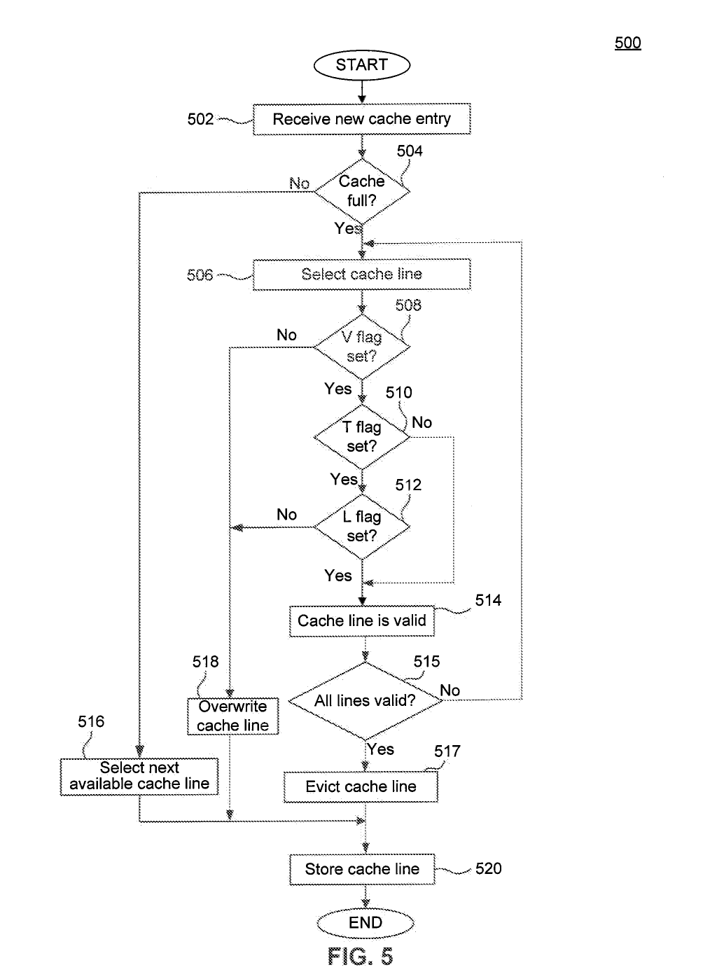

The transient data handling aspects of cache controller 109 is described below in relation to FIGS. 4 and 5.

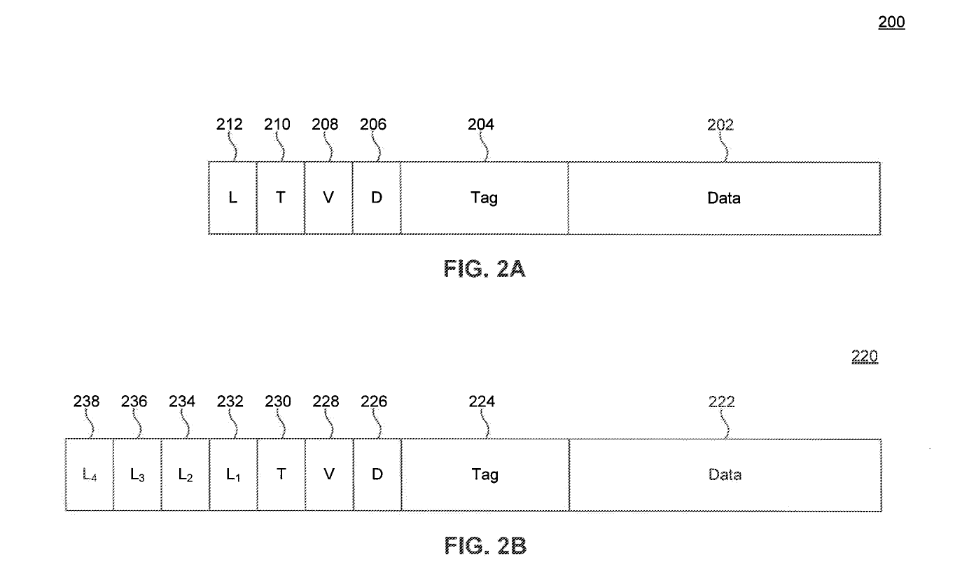

FIG. 2A illustrates a configuration of a cache line 200, in accordance with some embodiments. Cache line 200 includes cached data 202, tag 204 and flags 206-212. The cached data of the cache line, such as cache line 200, may be the unit of data copied from a memory, such as, system memory 103 to a cache, such as any of caches 143, 144, or 145. The cached data of the cache line may also be the unit of data copied from a memory to a cache associated with another processor. For example, cached data 202 may be copied from graphics memory 107 or system memory 103 to the GPU cache 110 one cache line at a time. The data stored in a cache line can be any size in bytes, and is typically configured to be of size 2^{m} bytes where m is an integer greater than 0.

Tag 204 corresponds to the address, in the primary memory associated with the cache, of the data stored in the cache line. For example, if cache line 200 is stored in cache 145, tag 204 may correspond to the address and/or the location of cached data 202 in system memory 103. If cache line 200 is stored in cache 110, then tag 204 may correspond to the address and/or the location of cached data 202 in GPU memory 107 or system memory 103. Several ways of structuring tag 204 are known. For example, depending on whether the cache is an associative cache, set associative cache, or direct mapped cache, tag 204 may be structured differently. The determination whether a particular data item of the memory is present in a cache is made by comparing the tags or portions of the tags to the desired memory address.

Flags 206-212 include one or more validity flags (“V flag”), one or more dirty flags (“D flag”), one or more transient data flags (“T flag”), and one or more live flags (“L flag”). In the illustrated embodiment, cache line 200 includes one valid flag and one dirty flag. As done in conventional caches, valid flag is set (e.g. value of 1) as an indicator when the cache line is consistent with (e.g. identical to) the corresponding data in the primary memory (i.e., the memory which is cached in each of the cache lines), and cleared (e.g. value of 0) when the cache line is not consistent with the primary memory. When a cache line is first stored in a cache, the valid flag is set. The dirty flag being set indicates that a local processor has updated the cache line and that the cache line should be written out to primary memory. For example, in a write-back cache, the dirty flag is set for a cache line that is updated by the local processor.

The T flag 210 and L flag 212 are stored with each cache line in accordance with some embodiments. The T flag indicates that the cache line includes transient data. The L flag indicates that the data associated with the cache line is live (e.g. useful or being referenced) at present. Thus, a cache line that has both the T and L flags set includes transient data that is currently live.

In some embodiments, the V, D, T and L flags can each be represented by a respective bit associated with each cache line in hardware. The bits may be integrated into each cache line. According to another embodiment, the bits may be maintained in a table where each entry in the table is associated with a respective cache line in a cache.

FIG. 2B illustrates a configuration of a cache line 220 in accordance with another embodiment. Cached data 222, tag 224, D flag 226, V flag 228, and T flag 230 have identical semantics to 202, 204, 206, 208 and 210 discussed above. However, in contrast to the embodiments illustrated in FIG. 2A, cache line 220 includes a plurality of L flags identified as L1, L2, L3 and L4, respectively, items 232, 234, 236 and 238. The cache line 220 can be used for caches, when it is necessary to have more than one transient memory area concurrently. For example, if the T flag and any one of the L1-L4 flags are [symbol] ent and live. Respective ones of the L1-L4 flags can be used for each of a plurality of processes. Each of the processes would have its transient data tagged differently from the other processes in the cache, thus allowing, for example, the invalidation of only the transient data corresponding to a particular process upon the termination of that process.

FIG. 3 illustrates a flowchart of a method 300 for a compiler pass for compiling code for processes, according to some embodiments. Method 300 compiles processes for execution on one or more of CPU 101, GPU 102, or other processor, such that transient data can be bulk invalidated in caches. In one example, method 300 operates in a system as described above in FIGS. 1, 2A and 2B. It is to be appreciated that method 300 may not be executed in the order shown or require all operations shown.

Method 300 can, for example, be used to compile code written and/or generated in one or more of a high level language such as C, C++, Cuda, OpenCL, or the like, in an intermediate language, or in an intermediate binary format. Method 300 can be used to generate, for example, the sequence of instructions 158 to be executed on a processor such as CPU 101 or GPU 102, using operations 302-314.

At operation 302, a line of code is parsed. At operation 304, it is determined whether the parsed line of code includes a memory operation, such as, for example, a read or write to a memory.

If the parsed line of code includes a memory operation, then method 300 proceeds to operation 306.

At operation 306, it is determined whether the memory operation is a transient memory operation (e.g. involving memory access to transient data). The determination whether an operation is a transient memory access can be based on one or more factors such as, access to memory locations identified as transient or long-lived, access to variables or data structures with clearly indicated local scope, and the like.

According to an embodiment, one or more separate regions of main memory (or virtual address space) may be reserved for transient data. For example, a separate region of system memory 103 may be reserved for transient data, and any access to that reserved region may be determined as a transient memory access. Accesses to the reserved region may be determined based upon, for example, the virtual addresses accessed.

According to another embodiment, transient data are aggregated in a subset of memory pages and a bit is added to the page table entries (PTEs) to identify transient data pages. The address translation (e.g. TLB or page table lookup) can then provide information on whether each access is to transient data or not. This technique may be desirable in programming models where there are already well-defined memory regions that are used for transient data (e.g. private and local memories in OpenCL that do not persist beyond the execution of a single kernel).

If the parsed line of code is determined to be a transient memory operation, then at operation 308 one or more corresponding transient load and/or store instructions are included in the compiled code. The “transient load” and “transient store” instructions are defined respectively as load and store operations for transient data only.

After operation 308, method 300 proceeds to operation 310. Operation 310 may also be reached from operation 304 if it is determined that the parsed line of code does not include a memory operation, or from operation 306 if it is determined that the memory operation is not a transient operation. At operation 310 it is determined whether the current parsed line of code represents an end of transient data scope. For example, when a plurality of separate transient regions are maintained, such as by using the cache line format shown in FIG. 2B, the transient data of a particular region may be invalidated when the process or kernel exits the scope of that region. If the current parsed line of code is an end of transient data scope, then, at operation 312, a TRIN instruction is inserted in the compiled code at a corresponding location. Otherwise, method 300 proceeds to insert a corresponding non-transient memory operation or other operation in the compiled code (not shown) and proceeds to operation 314 to obtain the next line of code to be parsed.

At operation 312, a “transient invalidate” (“TRIN”) instruction is inserted in to the compiled code. The TRIN instruction invalidates either all transient data or only the transient data identified as corresponding to the current process in the cache.

In an embodiment, the TRIN instruction causes a gang-invalidation of all the cache lines marked as having any transient data or only the transient data identified as corresponding to the current process. In another embodiment, transient cache lines may be gang-invalidated by clearing a particular one of the one or more L flags associated with each cache line. Cache lines are invalidated in response to the TRIN instruction by clearing the corresponding L flag for all transient data. Bulk invalidation of the transient data, such as that performed by gang-invalidation, is facilitated by identifying transient data in hardware, for example, in the manner described above in relation to FIGS. 2A and 2B. Bulk invalidation of transient data is substantially more efficient relative to identifying and invalidating individual cache lines having transient data.

Subsequent to the invalidation triggered by the TRIN instruction, the cache lines that are no longer valid, i.e. either cache lines with V bit not set (no valid data in the cache line) or cache lines with T bit set but none of the L bits set (dead transient data), can be considered for replacement in accordance with any replacement policy that is being used for the particular cache.

According to another embodiment, cache lines may include V, D and T flags but not the L flag, and the TRIN instruction would cause a hardware state machine to walk through each of the cache lines and invalidate any of the transient lines (i.e. any line with T bit set) by clearing the V bit on a TRIN operation.

At operation 314, it is determined whether more lines of code are to be parsed, and if yes, method 300 returns to operation 302 to select the next line of the sequence of instructions to be parsed.

If, at operation 314, it is determined that no more instructions are to be parsed of the current sequence of instructions being compiled, then the compiled code for the particular sequence of instructions has been completely generated, and method 300 ends. The compiled code may subsequently be executed on one or more processors such as, but not limited to, CPU 101 or GPU 102.

FIG. 4 is a flowchart of a method 400 for maintaining a cache, according to some embodiments. Method 400 may be performed in maintaining one or more of caches 143, 144, 145 or 110 of system 100. In an embodiment, one or more of the operations 402-426 of method 400 may not be performed, and/or operations 402-426 may be performed in an order other than that shown.

At operation 402, a process (which may also be referred to as a thread, workitem, kernel etc.) is started on one or more processors, such as, for example, CPU 101 or GPU 102 shown in FIG. 1. The process, if executing on CPU 101 (e.g. on one or more of cores 141 or 142) would access one or more of the caches 143, 144 and 145. The primary memory for the process executing on CPU 101 can be system memory 103. If the process is executing on GPU 102, then it may access cache 110. The primary memory for the process executing on GPU 102 can be GPU memory 107 and/or system memory 103. The executing process is represented as a sequence of instructions.

At operation 404, an instruction from the sequence of instructions is received for execution.

At operation 406, it is determined whether the received instruction is a load or store instruction, a TRIN instruction, or some other instruction. If the received instruction is some other instruction, the activity corresponding to the instruction is performed and method 400 returns to operation 404 to receive the next instruction to be executed.

If the received instruction is a load instruction or store instruction (i.e., a memory access instruction, also sometimes referred to respectively as read instruction or write instruction) method 400 proceeds to operation 408.

At operation 408, it is determined whether the memory access also involves a cache access. It should be noted that in some embodiments all memory accesses involve a cache access. If the current memory access instruction does not include a cache access, then the memory operation corresponding to the instruction is performed and method 400 returns to operation 404 to receive the next instruction to be executed.

If the current memory access instruction includes cache access, then method 400 proceeds to operation 410. At operation 410, it is determined whether the current instruction is a load instruction.

If the current instruction is a load instruction, method 400 proceeds to operation 412. At operation 412, it is determined whether the current instruction includes transient data.

The determination of whether the current instruction includes transient data may be based upon one or more of several factors. According to one embodiment, separate load and store instructions may be generated by a compiler, such as compiler 106, for transient data and long-lived data. According to another embodiment, the virtual address being accessed may be analyzed to determine if that address is in a region defined as being reserved for transient data. According to yet another embodiment, the address lookup in a TLB or page table may indicate whether the access is to a region of the memory reserved for transient data.

If the current instruction is a load instruction and includes transient data, then, at operation 413, it is determined whether the transient data results in a cache hit or miss. If the result is a cache hit, then the T and L flags are not changed. This avoids erroneously identifying lines that partially have non-transient data as transient. If, at operation 413, the result is a cache miss, then a cache line is populated with the transient data from the current instruction, and at operation 414, the T flag and the L flag of the cache line are set. In addition the V flag for the cache line is set. This setting of flags indicates that the cached data in the accessed cached line are valid, live transient data.

If, at operation 412, it is determined that the current instruction does not include transient data, then, at operation 416, the T flag and L flag are cleared from the cache line. Additionally, the V flag is set. This setting of flags indicates that the cached data in the accessed cached line are valid non-transient data.

If, at operation 410, it is determined that the current instruction is a store instruction, method 400 proceeds to operation 418.

At operation 418, it is determined whether the current store instruction includes transient data. The determination of whether the instruction includes transient data may be performed as described above in relation to operation 412. If yes (i.e. the store instruction includes transient data), then at operation 419, it is determined whether the transient data results in a cache hit or miss. If the result is a cache hit, then the T and L flags are not changed. If, at operation 419, the result is a cache miss, then a cache line is populated with the transient data from the current instruction, and the T flag and the L flag of the corresponding cache line are set at operation 422. In addition the V flag and the D flag are also set at operation 422. This setting of flags indicates that the cached data in the accessed cached line are valid, live transient data. Moreover, the D flag indicates that the cache line needs to be written back out to primary memory.

If, at operation 418, it is determined that the current store instruction does not include transient data, then the T flag and the L flag of the corresponding cache line are cleared at operation 420. Additionally, the V flag and the D flag of that cache line are set at operation 420. This setting of flags indicates that the cached data in the accessed cached line are valid non-transient data. Moreover, the D flag indicates that the cache line needs to be written back out to primary memory.

If, at operation 406, it was determined that the current instruction is a TRIN instruction, then method 400 proceeds to operation 424. At operation 424, the TRIN instruction causes the invalidation of some or all of the transient data in the cache.

Following, any of the operations 414, 416, 420, 422 or 424, method 400 proceeds to operation 426. At operation 426, it is determined whether more instructions are to be executed. If more instructions are to be executed, method 400 returns to operation 404 to execute the next instruction. If no more instructions are to be executed, method 400 proceeds to operation 428 where a TRIN instruction or equivalent may be performed to invalidate some or all of the transient data in the cache.

FIG. 5 is a flowchart of a method 500 for selecting a cache line to store new data in a cache, according to some embodiments. Method 500 may be performed at any point when a new cache line needs to be allocated, such as on cache misses. In an embodiment, one or more of the operations 502-520 of method 500 may not be performed, and/or operations 502-520 may be performed in an order other than that shown.

At operation 502 new data is received to be stored in a cache. For example, the received new data may be a caused by a load or store operation to a primary memory associated with the cache.

At operation 504, it is determined whether the cache is currently full. A cache full condition may depend on the cache discipline being used. In a fully associative cache, the cache full condition occurs when all entries are occupied. In a set associative cache, the cache full condition occurs when the particular set to which the new data is mapped is fully occupied. The cache full condition, as used in this document, indicates that the new data, when inserted in the cache, replaces an existing entry. The description of method 500 is set forth for determining a cache line to be replaced in a fully associative cache. However, the description here is applicable to set associative caches as well.

If, at operation 504, it is determined that the cache is not full, then at operation 516 the next available cache line is selected to store the new data. The next available cache line may be the next sequentially available cache line.

If, however, at operation 504, it is determined that the cache is full, then a currently occupied cache line must be selected to store the new data. The selection of the cache line to be replaced with the new data may be referred to as cache replacement, cache eviction etc. If the cache is found to be full, method 500 proceeds to operation 506.

At operation 506, a cache line is selected. Method 500 proceeds to operation 508 with the selected cache line. If, as shown at operation 508, the V flag of the selected cache line is not set (i.e. not valid) then method 500 proceeds to operation 518.

If the V flag is set, then at operation 510, the T flag is tested. If the T flag is not set, the cache line does not include transient data and method 500 proceeds to operation 514 where it is determined that the selected cache line is valid.

If the T flag is set (at operation 510), then the cache line includes transient data, and is tested for the L flag at operation 512. If the L flag is not set, then the transient data associated with the selected cache line is not live, and therefore, method 500 proceeds to operation 518.

If the L-flag is set, then the transient data associated with the selected cache line is live, and therefore may not be replaced or evicted. Method 500 proceeds to operation 514. Although described as separate operations, persons skilled in the art would appreciate that operations 508-512 can be performed as an operation in which all the corresponding bits are tested concurrently, or in any order.

At operation 514, arrived at either from operation 512 or directly from 510, it is determined that the selected cache line is valid and should not be replaced or evicted. After operation 514, method 500 proceeds to operation 515. At operation 515, it is determined whether all cache entries are valid (e.g. whether no cache lines are invalid or free). If not all cache entries are valid, then method 500 returns to operation 506 to select and test another cache line. If, however, it is determined at operation 515 that all cache entries are valid, then at operation 517 at least one cache entry is evicted in accordance with an eviction policy. Note that the data being evicted from the cache may be written to the primary memory of the D flag is set.

At operation 518, arrived at when a selected cache entry is determined to be invalid, the selected cache line is chosen to be overwritten by the new data. A cache line is invalid if neither of the following are true: V flag is set and T flag is not set (i.e. valid non-transient data); and V, T, and L flags are set (i.e. valid live transient data). Note that, if the D flag is set in a line that is not invalid, the cached data being overwritten is first written out to the primary memory.

At operation 520, the new transient data is stored in the selected cache line. Operation 520 may be reached following operation 516 in which a next available cache line is selected to store the new data, operation 517 in which a valid cache line was evicted to make room for the new data, or after operation 518 in which an invalid cache line is selected to be overwritten by the new data. After operation 520, method 500 ends.

Processing logic described with respect to FIGS. 3-4 can include commands and/or other instructions specified in a programming language such as C and/or in a hardware description language such as Verilog, RTL, or netlists, to enable ultimately configuring a manufacturing process through the generation of maskworks/photomasks to generate a hardware device embodying aspects described herein. According to an embodiment, the processing logic may be stored in a computer readable storage medium such as, but not limited to, a memory, hard disk, or flash disk.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the contemplated embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method, comprising:
identifying transient data upon storing the transient data in a cache memory; and
invalidating the identified transient data in the cache memory.

2. The method of claim 1, wherein the invalidating comprises:
marking respective ones of the transient data as expired based upon an execution of a sequence of instructions.

3. The method of claim 2, wherein the invalidating further comprises:
selecting the transient data based upon configured first indications in hardware; and
clearing respective second indications in hardware associated with each of the configured first indications.

4. The method of claim 1, further comprising:
configuring a live flag (L flag) associated with each of a plurality of cache lines in the cache,
wherein the invalidating comprises:
clearing the L flag associated with each of the plurality of cache lines.

5. The method of claim 4, further comprising:
determining as valid ones of the plurality of cache lines having either (1) a valid flag (V flag) set and a transient flag (T flag) cleared, or (2) the V flag, the T flag and the L flag set.

6. The method of claim 4, wherein the clearing the L flag comprises:
performing one or more gang-invalidate operations to clear the L flag of each cache line.

7. The method of claim 4, further comprising:
setting a transient flag (T flag) and the L flag of a cache line when a corresponding cached data is transient data.

8. The method of claim 4, wherein the clearing the L flag is performed in response to an instruction.

9. The method of claim 8, wherein the instruction is issued by software.

10. The method of claim 9, wherein the instruction is automatically generated by a compiler.

11. The method of claim 1, further comprising:
configuring a transient flag (T flag) and a plurality of live flags (L flags) with each of a plurality of cache lines in the cache memory, each L flag corresponding to a respective group of said transient data,
wherein the invalidating comprises:
clearing one of the L flags of each of a plurality of cache lines.

12. The method of claim 11, further comprising:
determining as valid ones of the plurality of cache lines having either (1) a valid flag (V flag) set and a transient flag (T flag) cleared, or (2) the V flag, the T flag and at least one of the L flags set.

13. A system, comprising:
a cache memory configured to associate a plurality of flags including a transient flag (T flag) and at least one live flag (L flag) with each cache line of the cache memory; and
a cache controller configured to:
identify transient data upon storing the transient data in the cache memory; and
invalidate the identified transient data in the cache memory.

14. The system of claim 13, further comprising:
a compiler configured to insert transient data invalidation (TRIN) instructions in a sequence of instructions,
wherein the cache controller is further configured to selectively invalidate transient data in the cache memory in response to one of the inserted TRIN instructions.

15. The system of claim 14, wherein the compiler is further configured to:
detect memory accesses involving transient data; and
insert a corresponding transient memory access instruction in the sequence of instructions for respective detected memory accesses.

16. The system of claim 13, wherein the cache controller is further configured to:
determine as valid ones of the plurality of cache lines having either (1) a valid flag (V flag) set and the T flag cleared, or (2) the V flag, the T flag and at least one of the L flags set.

17. The system of claim 13, wherein the cache controller is further configured to:
clear at least one of the L flags associated with each of the plurality of cache lines.

18. The system of claim 17, wherein the cache controller is further configured to:
perform one or more gang-invalidate operations to clear the at least one of the L flags of each cache line.

19. An article of manufacture comprising a computer readable storage medium having instructions configured for execution by one or more processors of a system to perform the operations comprising:
identifying transient data upon storing the transient data in a cache memory; and
invalidating the identified transient data in the cache memory.

20. The article of manufacture of claim 19, wherein the invalidating comprises:
selecting the transient data based upon configured first indications in hardware; and
clearing respective second indications in hardware associated with each of the configured first indications.

21. The article of manufacture of claim 19, wherein the instructions comprise hardware description language instructions that are usable to create a device to perform the operations.
